(19) United States
(12) Patent Application Publication
(10) Pub. No.: US 2019/0205944 A1
(43) Pub. Date: Jul. 4, 2019

(54) PROCESSING METHOD OF INTRODUCING CONTENT

(71) Applicant: DIJI SYSTEM CO., LTD, Okayama-shi (JP)

(72) Inventor: Yasunori USIYAMA, Okayama-shi (JP)

(73) Assignee: DIJI SYSTEM CO., LTD

(21) Appl. No.: 16/296,219

(22) Filed: Mar. 8, 2019

Related U.S. Application Data
(62) Division of application No. 15/479,284, filed on Apr. 5, 2017.
Application No. 15/479,284 is a continuation of application No. PCT/JP2015/080412, filed on Oct. 28, 2015.

(30) Foreign Application Priority Data
Nov. 17, 2014 (JP) 2014-232603

(51) Int. Cl. G06Q 30/02; H04L 29/08; G06F 13/00; G06Q 50/00

(52) U.S. Cl. CPC G06Q 30/0273; H04L 67/10; G06Q 30/02; H04L 67/146; G06F 13/00; H04L 67/02; G06Q 50/01; H04L 67/16

(57) ABSTRACT

The present invention provides a server device capable of easily generating and providing content introduction information with high reliability. A content introducer adds an URL information of a website introducing a content selected and acquired by the content introducer himself/herself to display the URL information. Thus, the content introduction information with high reliability can be easily generated and provided.

### CROSS-REFERENCES TO RELATED APPLICATIONS

This Application claims the benefit of priority and is a Continuation application of the prior International Patent Application No. PCT/JP2015/080412, with an international filing date of Oct. 28, 2015, which designated the United States, and is related to the Japanese Patent Application No. 2014-232603 filed Nov. 17, 2014, the entire disclosures of all applications are expressly incorporated by reference in their entirety herein.

### BACKGROUND OF THE INVENTION

1. Field of the Invention

The present invention relates to a server device.

2. Description of Related Art

Conventionally, as a social networking service (SNS), various services, such as blog, Twitter (registered trademark) and Facebook (registered trademark), are developed and widely spread throughout the world. In addition, in recent years, various advertising methods using the social networking service are proposed and developed (e.g., shown in Patent document 1).

Patent document 1: Japanese Unexamined Patent Application Publication No. 2008-171223

### BRIEF SUMMARY OF THE INVENTION

The present invention provides a server device capable of easily generating and providing content introduction information with high reliability.

In a server device of one embodiment of the present invention, the server device is connected to a social networking service server device, a content provider terminal device, a content introducer terminal device and a content acquirer terminal device, the server device has a storage unit that stores a content provided from the content provider terminal device and an address information of a website introducing the content in association with each other, and stores a social networking service identification information assigned to the content introducer terminal device, the social networking service identification information being unique to the content introducer terminal device; and a control unit that reads the content from the storage unit and transmits the content to the content introducer terminal device when the control unit receives a content acquisition request requesting to acquire a desired content from the content introducer terminal device, the control unit reads the address information of the website introducing the content and the social networking service identification information which is unique to the content introducer terminal device from the storage unit, transmits the address information and the identification information to the social networking service server device so that the address information is stored in a storage area assigned to the content introducer terminal device in the storage unit of the social networking service server device, and the control unit generates a fee information to be paid for introducing the content when the control unit receives the content acquisition request requesting from the content acquirer terminal device to acquire the content, and transmits the fee information to the content introducer terminal device.

By using the server device of the present invention, the content introduction information with high responsibility can be easily generated and provided.

### BRIEF DESCRIPTION OF THE DRAWINGS

FIGS. 1A and 1B are block diagrams showing a configuration of a content introduction system and a server device of the content introduction system of an embodiment of the present invention.

### DETAILED DESCRIPTION OF THE INVENTION

Hereafter, an embodiment of the present invention will be explained with reference to the drawings.

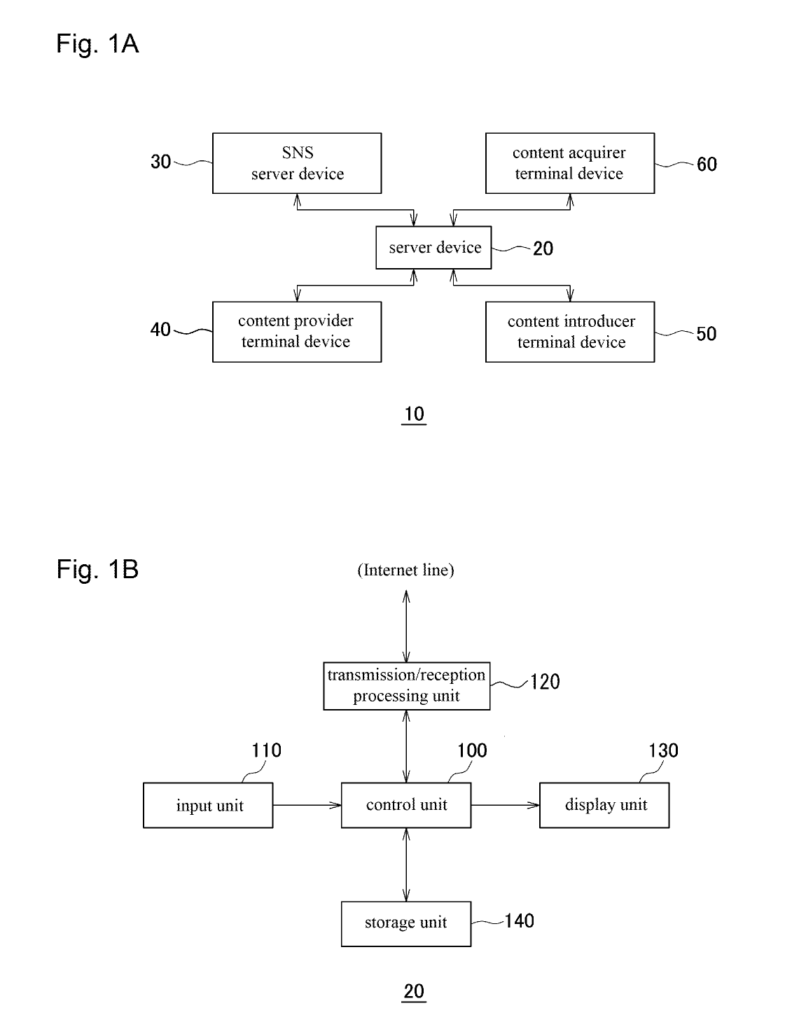

FIG. 1A shows a configuration of a content introduction system 10 of an embodiment of the present invention. FIG. 1B shows a detailed configuration of a server device 20 of the content introduction system 10.

The content introduction system 10 includes a server device 20 for realizing a content introduction service, a social networking service (SNS) server device 30, a content provider terminal device 40, a content introducer terminal device 50, and a content acquirer terminal device 60.

The SNS server device 30 is a server device for operating and managing the social networking service such as Twitter (registered trademark) and other blog services.

The server device 20 includes a control unit 100, an input unit 110, a transmission/reception processing unit 120, a display unit 130 and a storage unit 140. In the storage unit 140 of the server device 20, software required for providing the content introduction service are preliminarily stored. The control unit 100 controls the operation of each unit by reading and executing the software stored in the storage unit 140.

Note that the SNS server device 30, the content provider terminal device 40, the content introducer terminal device 50 and the content acquirer terminal device 60 also include the same configuration as the server device 20.

By the way, in the case of the present embodiment, a content introducer (a person introducing content) operates the content introducer terminal device 50 to use the social networking service provided by the SNS server device 30. Accordingly, an SNS identification information (identification information for SNS) which is unique to the content introducer is stored in the storage unit (not illustrated) of the SNS server device 30 when the content introducer directly accesses the SNS server device 30 via the Internet line. Thus, user registration of the content introducer to the SNS server device 30 has already been performed.

In this state, first, a content provider (a person providing content) performs user registration to the server device 20 enabling the content introducer to use the content introduction service provided by the server device 20.

Specifically, the content provider operates the content provider terminal device 40 to input a content provider information such as a system identification information (identification information for system) specified for using the server device 20. Thus, the content provider terminal device 40 transmits the content provider information to the server device 20 via the Internet line. Here, the system identification information is unique to the content provider.

When the control unit 100 of the server device 20 receives the content provider information via the transmission/reception processing unit 120, the control unit 100 stores the content provider information in the storage unit 140.

Then, when the content provider operates the content provider terminal device 40 to upload the content such as video and music stored in the content provider terminal device 40 to the server device 20, the content provider terminal device 40 transmits the desired content stored in the storage unit (not illustrated) and a URL (Uniform Resource Locator) information indicating the address information of the website introducing the content to the server device 20 via the Internet line together with the system identification information which is unique to the content provider.

When the control unit 100 of the server device 20 receives the content and the URL information of the content transferred together with the system identification information via the transmission/reception processing unit 120, the control unit 100 searches the content provider information having the system identification information corresponding to the received system identification information from the content provider information stored in the storage unit 140, and then stores the received content and the URL information of the content in the storage unit 140 in association with the searched content provider information. Thus, the content is registered. As explained above, various contents are sequentially stored and registered in the storage unit 140 of the server device 20.

Here, in the case of the present embodiment, when the content introducer operates the content introducer terminal device 50 to use the content introduction service provided by the server device 20, the content introducer terminal device 50 transmits the SNS identification information which is unique to the content introducer to the server device 20 via the Internet line.

When the control unit 100 of the server device 20 receives the transmitted SNS identification information which is unique to the content introducer via the transmission/reception processing unit 120, the control unit 100 stores the SNS identification information in the storage unit 140.

In this state, when the content introducer operates the content introducer terminal device 50 to access the server device 20, the control unit 100 of the server device 20 reads title information of a plurality of contents stored in the storage unit 140, and transmits the title information to the content introducer terminal device 50. Thus, a list of the title information of the contents is displayed on the display unit (not illustrated) of the content introducer terminal device 50.

In this state, when the content introducer performs a selection operation to select the content for downloading the desired content from the list of the title information displayed on the display unit (not illustrated) of the content introducer terminal device 50, the content introducer terminal device 50 generates a content selection information indicating that the content is selected and transmits the content selection information to the server device 20 via the Internet line.

When the control unit 100 of the server device 20 receives the transmitted content selection information via the transmission/reception processing unit 120, the control unit 100 reads the content indicated by the content selection information from the storage unit 140, and transmits the content to the content introducer terminal device 50. Thus, the content is stored in the storage unit (not illustrated) of the content introducer terminal device 50.

Simultaneously, the control unit 100 of the server device 20 reads the URL information of the website introducing the content and the SNS identification information unique to the content introducer from the storage unit 140, and transmits the URL information and the identification information to the SNS server device 30. Thus, the URL information of the website introducing the content and the SNS identification information unique to the content introducer in the storage unit (not illustrated) of the SNS server device 30 in association with each other.

Consequently, the URL information of the website introducing the content acquired by the content introducer is additionally displayed on the page of the content introducer in the social networking service provided by the SNS server device 30.

In this state, when a content acquirer (a person acquiring content) operates the content acquirer terminal device 60 for browsing the page of the content introducer in the social networking service provided by the SNS server device 30 and directly accesses the

SNS server device 30 via the Internet line, the content acquirer terminal device 60 displays the page of the content introducer transmitted from the SNS server device 30 on the display unit (not illustrated).

When the content acquire selects the URL information of the website introducing the content acquired by the content introducer from the page of the content introducer displayed on the display unit (not illustrated) of the content acquirer terminal device 60 by clicking the URL information, the content acquirer terminal device 60 generates a content introduction request information and transmits the content introduction request information to the server device 20 via the Internet line.

When the control unit 100 of the server device 20 receives the transmitted content introduction request information via the transmission/reception processing unit 120, the control unit 100 generates a content introduction information for introducing the content specified by the content introduction request information and transmits the content introduction information to the content acquirer terminal device 60. Thus, the content introduction information is displayed on the display unit (not illustrated) of the content acquirer terminal device 60.

When the content acquire operates to acquire the content while viewing the content introduction information displayed on the display unit (not illustrated) of the content acquirer terminal device 60, the content acquirer terminal device 60 generates a content acquisition request information and transmits the content acquisition request information to the server device 20 via the Internet line.

When the control unit 100 of the server device 20 receives the transmitted content acquisition request information via the transmission/reception processing unit 120, the control unit 100 reads the content specified by the content acquisition request information from the storage unit 140 and transmits the content to the content acquirer terminal device 60. Thus, the content is stored in the storage unit (not illustrated) of the content acquirer terminal device 60.

At that time, the control unit 100 of the server device 20 generates a fee information indicating a fee to be paid for introducing the content and transmits the fee information to the content introducer terminal device 50. Thus, the fee information is stored in the storage unit (not illustrated) of the content introducer terminal device 50.

As explained above, by using the present embodiment, the URL information of the website introducing the content selected and acquired by the content introducer himself/herself is additionally displayed. Thus, the content introduction information with high reliability can be easily generated and provided.

Although the server device 20 is applied as the server device in the above described embodiment, the present invention is not limited to the server device 20. Other server devices can be applied as long as the social networking service server device, the content provider terminal device 40, the content introducer terminal device 50 and the content acquirer terminal device 60 are connected to the server device.

Although the storage unit 140 is applied as the storage unit in the above described embodiment, the present invention is not limited to the storage unit 140. Other various storage units can be applied as long as the storage device stores the content provided by the content provider terminal device 40 and the address information of the website introducing the content in association with each other and stores the social networking service identification information unique to the content introducer terminal device 50 and assigned to the content introducer terminal device 50.

Although the control unit 100 is applied as the control unit in the present embodiment, the present invention is not limited to the control unit 100. Other various control units can be applied as long as the control unit reads the desired content from the storage unit 140 and transmits the content to the content introducer terminal device 50 and reads the address information of the website introducing the content and the social networking service identification information unique to the content introducer terminal device 50 from the storage unit 140 and transmits the address information and the social networking service identification information to the social networking service server device 30 when the control unit receives the content acquisition request requesting to acquire the desired content from the content introducer terminal device 50, thus the address information is stored in the storage area assigned to the content introducer terminal device 50 in the storage unit (not illustrated) of the social networking service server device 30, and the control unit generates the fee information to be paid for introducing the content and transmits the fee information to the content introducer terminal device 50 when the control unit receives the content acquisition request requesting to acquire the content from the content acquirer terminal device 60.

Namely, in the present embodiment, a processing method of introducing the content processed by the content introduction system 10 by connecting the service server device 30, the content provider terminal device 40, the content introducer terminal device 50 and the content acquirer terminal device 60 with the server device 20 is comprised of: a step of storing the social networking service identification information unique to the content introducer in the storage unit (not illustrated) of the social networking service server device 30 according to an input operation of the content introducer in the content introducer terminal device 50; a step of transmitting the system identification information which is unique to the content provider and selected to use the server device 20 from the content provider terminal device 40 to the server device 20 as the content provider information according to an input operation of the content provider in the content provider terminal device 40; a step of storing the content provider information in the storage unit 140 of the server device 20 when the content provider information is received by the server device 20; a step of transmitting the desired content stored in the storage unit (not illustrated) of the content provider terminal device 40 and the address information of the website introducing the content from the content provider terminal device 40 to the server device 20 together with the system identification information unique to the content provider according to an input operation of the content provider in the content provider terminal device 40; a step of searching the content provider information having the system identification information corresponding to the received system identification information from the content provider information stored in the storage unit 140 of the server device 20 and storing the received content, the address information and the searched content provider information in the storage unit 140 of the server device 20 in association with each other when the content and the address information transmitted together with the system identification information are received by the server device 20; a step of transmitting the social networking service identification information unique to the content introducer from the content introducer terminal device 50 to the server device 20 according to an input operation of the content introducer in the content introducer terminal device 50; a step of storing the social networking service identification information in the storage unit 140 of the server device 20 when the social networking service identification information unique to the content introducer is received by the server device 20; a step of reading the title information of a plurality of contents from the storage unit 140 of the server device 20 according to an input operation of the content introducer in the content introducer terminal device 50 and transmitting the title information from the server device 20 to the content introducer terminal device 50 to display the list of title information of the contents on the display unit (not illustrated) of the content introducer terminal device 50; a step of generating the content selection information indicating that the content is selected and transmitting the content selection information from the content introducer terminal device 50 to the server device 20 when the content introducer performs a selection operation to select the desired content from the list of the title information displayed on the display unit (not illustrated) of the content introducer terminal device 50; a step of reading the content indicated by the content selection information from the storage unit 140 of the server device 20 and transmitting the content to the content introducer terminal device 50 to store the content in the storage unit (not illustrated) of the content introducer terminal device 50 when the server device 20 receives the content selection information; a step of reading the address information of the website introducing the content and the social networking service identification information unique to the content introducer from the storage unit 140 of the server device 20 and transmitting the address information and the social networking service identification information to the social networking service server device 30 to store the address information of the website introducing the content and the social networking service identification information unique to the content introducer in the storage unit (not illustrated) of the social networking service server device 30 in association with each other; a step of accessing the social networking service server device 30 according to an input operation of the content acquirer in the content acquirer terminal device 60 to display a page data of the content introducer transmitted from the social networking service server device 30 on the display unit (not illustrated) of the content acquirer terminal device 60; a step of generating a content introduction request information and transmitting the content introduction request information from the content acquirer terminal device 60 to the server device 20 when the content acquire selects the address information of the website introducing the content acquired by the content introducer from the page data of the content introducer displayed on the display unit (not illustrated) of the content acquirer terminal device 60 by clicking the address information; a step of generating a content introduction information for introducing the content specified by the content introduction request information when the server device 20 receives the content introduction request information and transmitting the content introduction information from the server device 20 to the content acquirer terminal device 60 to display the content introduction information on the display unit (not illustrated) of the content acquirer terminal device 60; a step of generating the content acquisition request information and transmitting the content acquisition request information from the content acquirer terminal device 60 to the server device 20 when the content acquire operates to acquire the content based on the content introduction information displayed on the display unit (not illustrated) of the content acquirer terminal device 60; a step of reading the content specified by the content acquisition request information from the storage unit 140 of the server device 20 when the server device 20 receives the content acquisition request information and transmitting the content to the content acquirer terminal device 60 to store the content in the storage unit (not illustrated) of the content acquirer terminal device 60; and a step of generating a fee information to be paid for introducing the content in the server device 20 and transmitting the fee information to the content introducer terminal device 50 to store the fee information in the storage unit (not illustrated) of the content introducer terminal device 50.

Note that, this invention is not limited to the above-mentioned embodiments. Although it is to those skilled in the art, the following are disclosed as the one embodiment of this invention.

Mutually substitutable members, configurations, etc. disclosed in the embodiment can be used with their combination altered appropriately.

Although not disclosed in the embodiment, members, configurations, etc. that belong to the known technology and can be substituted with the members, the configurations, etc. disclosed in the embodiment can be appropriately substituted or are used by altering their combination.

Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

### DESCRIPTION OF THE REFERENCE NUMERALS

10 content introduction system

20 server device

30 social networking service (SNS) server device

40 content provider terminal device

50 content introducer terminal device

60 content acquirer terminal device

100 control unit

140 storage unit

1. (canceled)

2. A processing method of introducing a content processed by a content introduction system by connecting a social networking service server device, a content provider terminal device, a content introducer terminal device and a content acquirer terminal device with a server device, the method comprising:
a step of storing a social networking service identification information unique to a content introducer in a first storage unit of the social networking service server device according to a first input operation of the content introducer in the content introducer terminal device;
a step of transmitting a system identification information which is unique to a content provider and selected to use the server device from the content provider terminal device to the server device as a content provider information according to a second input operation of the content provider in the content provider terminal device;
a step of storing the content provider information in a second storage unit of the server device when the content provider information is received by the server device;
a step of transmitting a desired content stored in a third storage unit of the content provider terminal device and an address information of a website introducing the content from the content provider terminal device to the server device together with the system identification information unique to the content provider according to a third input operation of the content provider in the content provider terminal device;
a step of searching the content provider information having the system identification information corresponding to the received system identification information from the content provider information stored in the second storage unit of the server device and storing a received content, the address information and the searched content provider information in the second storage unit of the server device in association with each other when the content and the address information transmitted together with the system identification information are received by the server device;
a step of transmitting the social networking service identification information unique to the content introducer from the content introducer terminal device to the server device according to a fourth input operation of the content introducer in the content introducer terminal device;
a step of storing the social networking service identification information in the second storage unit of the server device when the social networking service identification information unique to the content introducer is received by the server device;
a step of reading a title information of a plurality of contents from the second storage unit of the server device according to a fifth input operation of the content introducer in the content introducer terminal device and transmitting the title information from the server device to the content introducer terminal device to display a list of the title information of the contents on a first display unit of the content introducer terminal device;
a step of generating a content selection information indicating that the content is selected and transmitting the content selection information from the content introducer terminal device to the server device when the content introducer performs a selection operation to select the desired content from the list of the title information displayed on the first display unit of the content introducer terminal device;
a step of reading the content indicated by the content selection information from the second storage unit of the server device and transmitting the content to the content introducer terminal device to store the content in a fourth storage unit of the content introducer terminal device when the server device receives the content selection information;
a step of reading the address information of the website introducing the content and the social networking service identification information unique to the content introducer from the second storage unit of the server device and transmitting the address information and the social networking service identification information to the social networking service server device to store the address information of the website introducing the content and the social networking service identification information unique to the content introducer in the first storage unit of the social networking service server device in association with each other;
a step of accessing the social networking service server device according to a sixth input operation of a content acquirer in the content acquirer terminal device to display a page data of the content introducer transmitted from the social networking service server device on a second display unit of the content acquirer terminal device;
a step of generating a content introduction request information and transmitting the content introduction request information from the content acquirer terminal device to the server device when the content acquirer selects the address information of the website introducing the content acquired by the content introducer from the page data of the content introducer displayed on the second display unit of the content acquirer terminal device by clicking the address information;
a step of generating a content introduction information for introducing the content specified by the content introduction request information when the server device receives the content introduction request information and transmitting the content introduction information from the server device to the content acquirer terminal device to display the content introduction information on the second display unit of the content acquirer terminal device;
a step of generating a content acquisition request information and transmitting the content acquisition request information from the content acquirer terminal device to the server device when the content acquire operates to acquire the content based on the content introduction information displayed on the second display unit of the content acquirer terminal device;
a step of reading the content specified by the content acquisition request information from the second storage unit of the server device when the server device receives the content acquisition request information and transmitting the content to the content acquirer terminal device to store the content in the second storage unit of the content acquirer terminal device; and
a step of generating a fee information to be paid for introducing the content in the server device and transmitting the fee information to the content introducer terminal device to store the fee information in the fourth storage unit of the content introducer terminal device.
